(19) United States
(12) Patent Application Publication
(10) Pub. No.: US 2009/0192649 A1
(43) Pub. Date: Jul. 30, 2009

(54) ROBOT WITH PERSONALITY CHARACTERS AND ROBOT BEHAVIOR CONTROL METHOD

(75) Inventor: HUNG YEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/266,559

(22) Filed: Nov. 7, 2008

(30) Foreign Application Priority Data
Jan. 24, 2008 (CN) 200810300202.2

(51) Int. Cl. B25J 13/08; G05B 21/00

(52) U.S. Cl. 700/253; 700/250; 901/46

(57) ABSTRACT

The present invention relates to a robot with personality characters. The robot communicates with another robot within a predetermined coverage area. The robot stores at least one personality attribute of the robot, at least one personality attribute of another robot, at least one predetermined action, and a relationship among the personality attribute of the robot, the personality attribute of another robot and the predetermined action. The present invention also provides a behavior control method adapted for the robot. In the method, the robot detects a second robot within the predetermined area to obtain the personality attribute of the second robot, fetches the personality attribute of the robot, and performs the predetermined action according to the relationship.

### TECHNICAL FIELD

The present invention relates to a robot and, more particularly, to a robot with personality characters and a behavior control method adapted for a robot.

### GENERAL BACKGROUND

There are a variety of robots on the market today, such as electronic toys, electronic pets, and the like. In such a robot, there are predetermined behavioral models for each growth stage, and the current behavioral model is switched to another behavioral model of one of the above described “growth stages” on the basis of selection by the user, accumulation of elapsed time or the like to thereby express the “growth.” According to this method, however, the current behavioral model is switched to a new behavioral model every time the robot “grows,” and therefore, the robot starts a new action for each “growth” as if the character was suddenly changed. Consequently, the robot outputs a corresponding action according to a variety of the characters of the growth stage, but the robot does not interact with other robots and output different actions according to personality characters of other robots, making the robot repetitiously dull and boring.

Accordingly, what is needed in the art is a robot with personality characters that overcomes the aforementioned deficiencies.

### BRIEF DESCRIPTION OF THE DRAWINGS

The components in the drawings are not necessarily drawn to scale, the emphasis instead being placed upon clearly illustrating the principles of the robot. Moreover, in the drawings, like reference numerals designate corresponding parts throughout the several views.

FIG. 1 is a block diagram of a hardware infrastructure of a robot with personality characters in accordance with an exemplary embodiment.

FIG. 2 is a personality attribute table of the robot of FIG. 1 in accordance with an exemplary embodiment.

FIG. 3 is a relationship table of the robot of FIG. 1 in accordance with an exemplary embodiment.

FIG. 4 is a flowchart illustrating a behavior control method implemented by the robot of FIG. 1, in accordance with an exemplary embodiment.

### DETAILED DESCRIPTION OF THE EMBODIMENTS

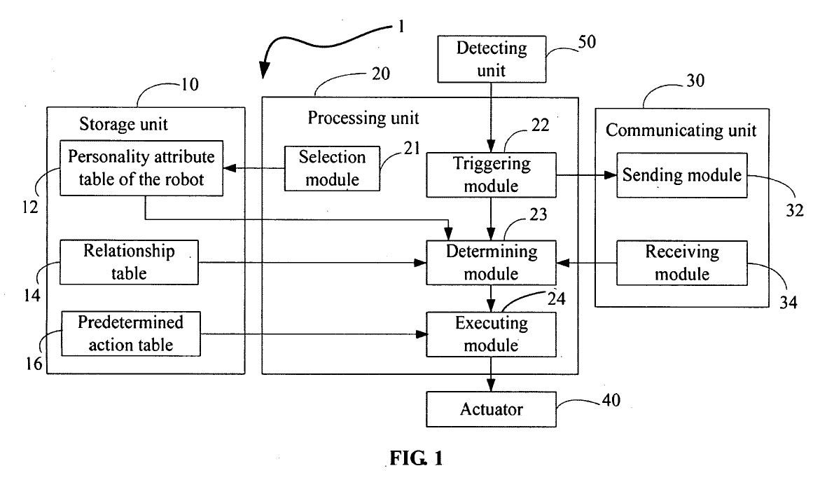

FIG. 1 is a block diagram of a hardware infrastructure of a robot with personality characters in accordance with an exemplary embodiment. The robot with personality characters (hereinafter “the robot”) 1 communicates with another robot within a predetermined coverage area. The predetermined coverage area may be a range, such as a five meter radius from the robot 1 or another robot. The robot 1 has personality attributes itself. Another robot has personality attributes itself.

The robot 1 includes a storage unit 10, a processing unit 20, a communicating unit 30, an actuator 40, and a detecting unit 50. The storage unit 10 stores a personality attribute table 12 of the robot 1, a relationship table 14, and a predetermined action table 16. The predetermined action table 16 stores a plurality of predetermined actions.

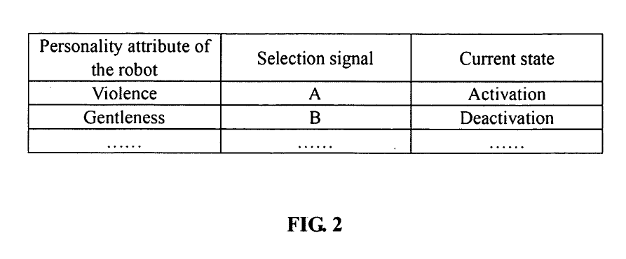

FIG. 2 is a personality attribute table 12 of the robot 1 of FIG. 1 in accordance with an exemplary embodiment. As shown in FIG. 2, the personality attribute table 12 of the robot 1 includes a personality attribute column, a selection signal column, and a current state column. The personality attribute column records a plurality of personality attributes of the robot 1, such as “violence”, “gentleness”, and the like. Each of the personality attributes is assigned with a selection signal. For example, the “violence” personality attribute is assigned with a selection signal “A”. That is, if a selection signal “A” is selected, a current personality attribute of the robot 1 is the “violence” personality attribute.

The selection signal column records the selection signal of each personality attribute of the robot 1. The current state column records a current state of each personality attribute of the robot 1. Once a personality attribute of the robot 1 is selected, the current state of the personality attribute is in the activation state, and the current states of other personality attributes of the robot 1 are all in the deactivation state. For example, if a “B” selection signal is selected, the personality attribute of the robot 1 is “gentleness” and the current state of the personality attribute “gentleness” of the robot 1 is in the activation state.

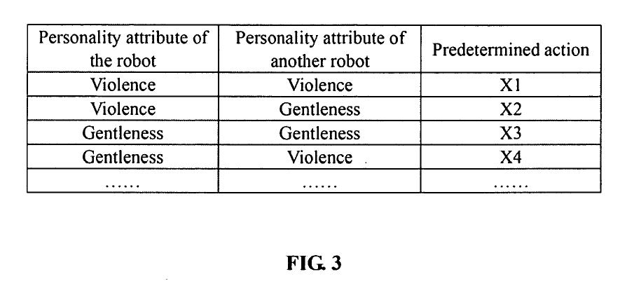

FIG. 3 is a relationship table of the robot 1 of FIG. 1 in accordance with an exemplary embodiment. The relationship table 14 stores relationships among the personality attributes of the robot 1, the personality attributes of another robot, and the predetermined actions (hereinafter, “the robot relationship”). As shown in FIG. 3, the relationship table 14 includes a personality attribute of the robot column, a personality attribute of another robot column, and a predetermined action column. The personality attribute of the robot column records a plurality of personality attributes of the robot 1, such as violence, gentleness, and the like. The personality attribute of another robot column records a plurality of personality attributes of another robot, such as violence, gentleness, and the like.

The predetermined action column records a plurality of predetermined actions associated with the personality attributes of the robot 1 and the personality attributes of another robot. For example, when the personality attribute of the robot 1 is the “violence” personality attribute, and the personality attribute of another robot is the “gentleness” personality attribute, the robot 1 acquires a “X2” predetermined action.

In another exemplary embodiment, the robot 1 has a fixed personality attribute, that is, the robot 1 has only one personality attribute, in such condition, the personality attribute table 12 of the robot 1 can be omitted.

The detecting unit 50 is configured for detecting whether there is another robot within the predetermined coverage area, and transmitting a prompt signal to the processing unit 20 if there is another robot within the predetermined coverage area. The communicating unit 30 is configured for communicating with another robot within the predetermined coverage area, sending a search signal to another robot, and receiving a response signal with a mark from another robot. The communicating unit 30 further includes a sending module 32 and a receiving module 34. The sending module 32 is configured for sending the search signal to another robot according to a control of the processing unit 20, and the receiving module 34 is configured for receiving the response signal with the mark from another robot. The communicating unit 30 can be a BLUETOOH module.

The processing unit further includes a selection module 21, a triggering module 22, a determining module 23, and an executing module 24. The selection module 21 is configured for generating the selection signal to select the personality attribute of the robot 1. As shown in FIG. 2, for example, the selection module 21 generates the “B” selection signal to select the “gentleness” personality attribute of the robot 1 from the user. In another exemplary embodiment, the robot 1 has only one personality attribute, in such condition, the robot 1 does not need the selection module 21.

The triggering module 22 is configured for controlling the communicating unit 30 to send the search signal to another robot when receiving the prompt signal from the detecting unit 50. The determining module 23 is configured for determining whether the receiving module 34 receives the response signal with the mark within a predetermined time period, obtaining the personality attribute of another robot if the receiving module 34 receives the response signal with the mark, fetching the personality attribute of the robot 1 in the storage unit 10, and acquiring the robot relationship in the relationship table 14. The executing module 24 is configured for fetching the predetermined action in the predetermined action table 16 according to the robot relationship. The actuator 40 is positioned in every movement part of the robot 1 and performs the predetermined action.

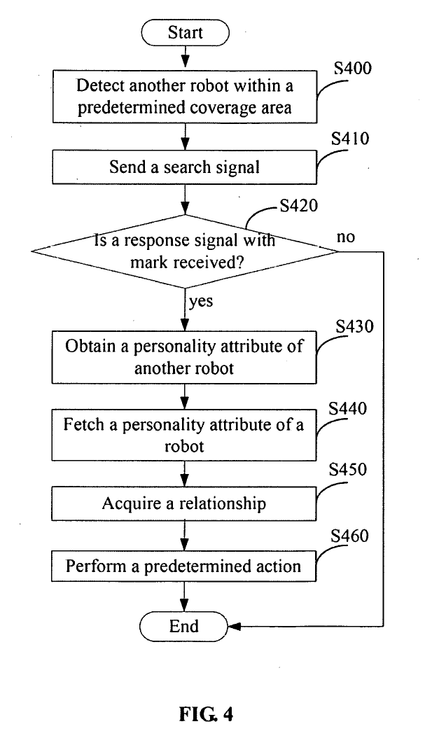

FIG. 4 is a flowchart illustrating a behavior control method implemented by the robot of FIG. 1, in accordance with an exemplary embodiment. In step S400, the selection module 21 generates a selection signal to select the personality attribute of the robot 1 from the user, and the detecting unit 50 detects another robot within the predetermined coverage area and sends the prompt signal to the triggering module 22. In another exemplarily embodiment, the detecting unit 50 directly detects another robot within the predetermined coverage area and sends the prompt signal to the triggering module 22. In step S410, the triggering module 22 controls the sending module 32 to send the search signal. In step S420, the determining module 23 determines whether the receiving module 34 receives the response signal with the mark from another robot within the predetermined time period. If the receiving module 34 does not receive the response signal with the mark within the predetermined time period, the procedure ends.

If the receiving module 34 receives the response signal with the mark from another robot within the predetermined time period, in step S430, the determining module 23 obtains the personality attribute of another robot according to the response signal with mark. In step S440, the determining module 23 fetches the personality attribute of the robot 1 in the personality attribute table 12. In step S450, the determining module 23 acquires the robot relationship in the relationship table 14. In step S460, the executing module 24 fetches the predetermined action in the predetermined action table 16 according to the robot relationship, the actuator 40 performs the predetermined action, and the procedure ends.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A robot with personality characters capable of communicating with another robot within a predetermined coverage area, the robot comprising:
a storage unit, for storing at least one personality attribute of the robot, at least one personality attribute of another robot, at least one predetermined action, and a relationship among the personality attribute of the robot, the personality attribute of another robot, and the predetermined action;
a detecting unit, for detecting another robot within the predetermined coverage area;
a communicating unit, for sending a search signal to another robot, and receiving a response signal with a mark from another robot;
a triggering module configured for controlling the communicating unit to send the search signal when the detecting unit detects another robot;
a determining module configured for determining whether the communicating unit receives the response signal with the mark within a predetermined time period, obtaining the personality attribute of another robot if the communicating unit receives the response signal with the mark, fetching the personality attribute of the robot in the storage unit, and acquiring the relationship among the personality attribute of the robot, the personality attribute of another robot, and the predetermined action in the storage unit; and
an actuator, for performing the predetermined action.

2. The robot as recited in claim 1, further comprising a selection module, configured for generating a selection signal to select the personality attribute of the robot.

3. The robot as recited in claim 1, further comprising an executing module, configured for acquiring the predetermined action in the storage unit and sending the acquired predetermined action to the actuator.

4. The robot as recited in claim 1, wherein the communicating unit further comprises a sending module for sending the search signal and a receiving module for receiving the response signal with the mark.

5. The robot as recited in claim 1, wherein the communicating unit is a BLUETOOTH module.

6. The robot as recited in claim 1, wherein the storage unit further stores a personality attribute table which defines relationships among a personality attribute, a selection signal and a current state; the personality attribute of the robot is fetched from the personality attribute table.

7. The robot as recited in claim 1, wherein the storage unit further stores a predetermined action table which defines relationships between the predetermined action and at least one action to be performed by the actuator.

8. A behavior control method for a robot, wherein the robot is capable of communicating with a second robot within a predetermined coverage area, and the robot stores at least one personality attribute of the robot, at least one personality attribute of the second robot, a predetermined action, and at least one relationship among the personality attribute of the robot, the personality attribute of the second robot, and the predetermined action, the method comprising:
detecting the second robot within the predetermined coverage area;
sending a search signal and receiving a response signal with a mark from the second robot;
obtaining the personality attribute of the second robot;
fetching the personality attribute of the robot;
acquiring the relationship among the personality attribute of the robot, the personality attribute of the second robot, and the predetermined action; and
performing the predetermined action.

9. The behavior control method as recited in claim 8, further comprising:
generating a selection signal to select the personality attribute of the robot.
